(19) United States
(12) Patent Application Publication
(10) Pub. No.: US 2012/0278010 A1
(43) Pub. Date: Nov. 1, 2012

(54) OBJECT INFORMATION ACQUIRING APPARATUS

(75) Inventor: Yoshiko Wada, Kawasaki-shi (JP)

(73) Assignee: CANON KABUSHIKI KAISHA, Tokyo (JP)

(21) Appl. No.: 13/393,954

(22) PCT Filed: Nov. 24, 2011
(86) PCT No.: PCT/JP2011/077740

§ 371 Date: Mar. 2, 2012

(30) Foreign Application Priority Data
Nov. 25, 2010 (JP) 2010-262390

(51) Int. Cl. G01N 29/44

(52) U.S. Cl. 702/56; 702/189

(57) ABSTRACT

The present invention provides an object information acquiring apparatus having: a probe which includes a plurality of elements that receive an acoustic wave propagated through an object to generate element signals; a pseudo-signal generator which computes a phase shift between element signals received by at least two elements out of the plurality of elements, and generates a pseudo-signal assumed to be received at a position on the probe that is different from the positions of the elements which have received the element signals in use a result of computation; and a signal processor which obtains object information based on the element signals received by the plurality of elements and the pseudo-signal.

### TECHNICAL FIELD

The present invention relates to an object information acquiring apparatus.

### BACKGROUND ART

As an apparatus for imaging inside a test sample (object) using ultrasonic waves (acoustic waves), a photoacoustic diagnostic apparatus which is used for medical diagnosis, for example, has been proposed. The photoacoustic diagnostic apparatus irradiates a laser pulsed light onto an object, and generates an image of inside the object based on acoustic waves generated as a result of tissue in the object absorbing the energy of the irradiated light. By detecting the time-based changes of the acoustic waves received at a plurality of locations surrounding the object and mathematically analyzing the obtained signals, that is by reconstructing an image, this apparatus can two-dimensionally or three-dimensionally visualize information related to the optical characteristic values inside the object.

In such an apparatus that generates images using ultrasonic waves from inside the object, an ultrasonic probe is used as an ultrasonic receiving sensor, and in the case of a standard photoacoustic diagnostic apparatus, photoacoustic waves from a plurality of locations are simultaneously received by an ultrasonic probe having a plurality of elements. However if some of the plurality of receiving elements of the ultrasonic probe malfunction, or if some elements are intentionally omitted, as in the case of a sparse array probe, spatial omission is generated in the acquired signals.

If an image is reconstructed using a plurality of signal data where signals are spatially omitted, it is known that artifacts appear in the acquired image, and image quality deteriorates. Patent Literature 1 (PTL 1), for example, proposes a method for generating new pseudo-signals by simply averaging the neighboring element signals when signal data is spatially omitted, so as to interpolate the omitted signals by the pseudo-signals.

### CITATION LIST

### Patent Literature

PTL 1: Japanese Patent Application Laid-Open No. 2003-135461

### SUMMARY OF INVENTION

### Technical Problem

In the case of the method disclosed in Patent Literature 1, however, a spatially omitted signal is interpolated with a signal generated by simply averaging the element signals from the neighboring elements. Therefore if the time lag is major between the signals of the adjacent elements and a signal which is supposed to be acquired at a position of the omitted element, then the new interpolation signal generated based on signals of adjacent elements becomes a signal indicated by the solid line in FIG. 7. As a result, the form of the signal indicated by the broken line in FIG. 7, which actually reaches the position of the omitted element, cannot be reproduced sufficiently.

With the foregoing in view, it is an object of the present invention to provide a technology for generating a pseudo-signal, to be received when an element is supposed to exist in a position of the omitted element on the probe.

### Solution to Problem

This invention provides an object information acquiring apparatus, comprising:

a probe which includes a plurality of elements that receive an acoustic wave propagated through an object to generate element signals;

a pseudo-signal generator which computes a phase shift between element signals received by at least two elements out of the plurality of elements, and generates a pseudo-signal to be received at a position on the probe that is different from the positions of the elements that have received the element signals in use of a result of computation; and

a signal processor which obtains object information based on the element signals received by the plurality of elements and the pseudo-signal.

### Advantageous Effects of Invention

According to the present invention, a technology for generating a pseudo-signal to be received is supposed to exist in a position of the omitted element on the probe can be provided.

Further features of the present invention will become apparent from the following description of exemplary embodiments with reference to the attached drawings.

### BRIEF DESCRIPTION OF DRAWINGS

FIG. 1 is a block diagram depicting a configuration of a photoacoustic diagnostic apparatus of the present invention;

FIG. 2 are schematic diagrams depicting a probe used for the present invention;

FIG. 3 are graphs showing forms of a generated pseudo-signal and a signal based on which the pseudo-signal is generated;

FIG. 4 is a block diagram depicting a configuration of an ultrasonic apparatus of the present invention;

FIG. 5 shows absorption coefficient distributions acquired using a sparse array probe;

FIG. 6 shows the absorption coefficient distributions acquired using a probe having inoperative elements; and

FIG. 7 is a diagram depicting a case of generating a pseudo-signal according to prior art.

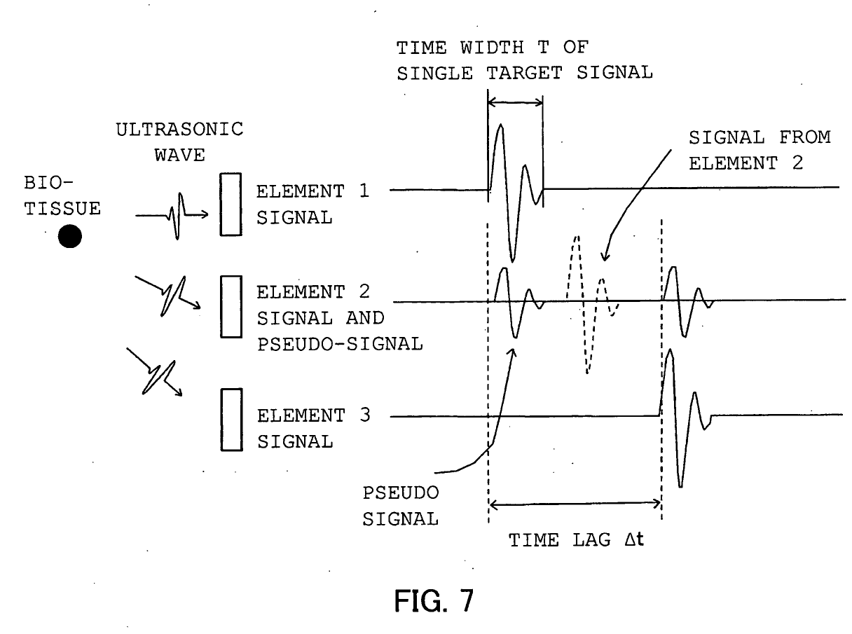

### DESCRIPTION OF EMBODIMENTS

Embodiments of the object information acquiring apparatus according to the present invention will now be described, using an example of a photoacoustic diagnostic apparatus, with reference to the drawings. In the following description, an ultrasonic wave is used as a typical example of a photoacoustic wave. The object information acquiring apparatus of the present invention includes an apparatus that utilizes ultrasonic echo technology, which transmits an ultrasonic wave to an object, and receives a reflected wave reflected from inside the object (reflected ultrasonic wave), whereby the object information is acquired as image data or numeric data. The object information acquiring apparatus also includes an apparatus that utilizes a photoacoustic effect, in which the apparatus receives an acoustic wave (typically an ultrasonic wave) generated in the object by irradiating light (an electromagnetic wave) onto the object, whereby the object information is acquired as image data or numeric data.

In the case of the former apparatus utilizing ultrasonic echo technology, the object information to be acquired is information reflecting the difference of the acoustic impedance of tissue in the object. In the case of the latter apparatus that utilizes the photoacoustic effect, the object information to be acquired is an acoustic wave generation source distribution generated by irradiating light, an initial pressure distribution in the object, a light energy absorption density distribution derived from the initial pressure distribution, an absorption coefficient distribution and a concentration distribution of the substance constituting the tissue. Or the object information to be acquired is an absorption coefficient value, concentration value, or the like, of a light absorber in the object. The concentration distribution of the substance is, for example, oxygen saturation distribution and oxidation-reduction hemoglobin concentration distribution.

### (Operation of Photoacoustic Diagnostic Apparatus)

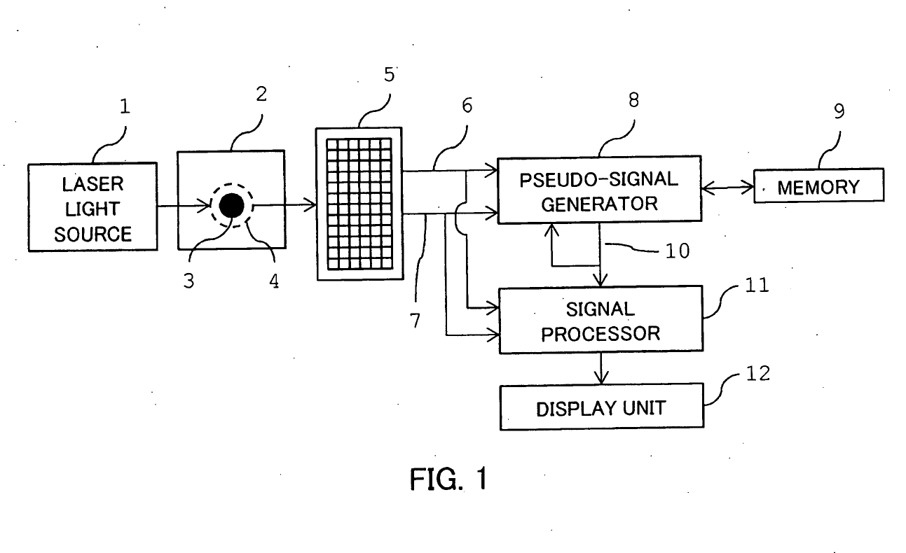

FIG. 1 is a block diagram depicting a configuration of the photoacoustic diagnostic apparatus according to the present embodiment. As FIG. 1 shows, the photoacoustic diagnostic apparatus according to the present embodiment irradiates a pulsed light from a laser light source 1 onto an object 2, which is a target of diagnosis. The pulsed light is absorbed by a light absorber 3 in the object 2, and an photoacoustic wave 4, which is an ultrasonic wave (acoustic wave), is generated. The generated photoacoustic wave 4 propagates through the object, and is converted into electric signals (element signals) by a plurality of elements included in an ultrasonic probe 5.

Electric signals are amplified and converted into digital signals, and then the omitted portions of the elements are interpolated by a pseudo-signal generator 8. Then all the signals are processed to reconstruct an image by the signal processor 11, and the reconstructed image is displayed by the display unit 12. Each block will now be described in detail.

### (Laser Light Source)

The laser light source 1 generates a pulsed light in a nanosecond order. To obtain high output, laser is preferable, but a light emitting diode may be used instead of a laser. For the laser, a solid-state laser, a gas laser, a dye laser, a semiconductor laser and various other lasers can be used. The timing of irradiation, waveform and intensity among other factors are controlled by a light source control unit, which is not illustrated.

### (Ultrasonic Probe)

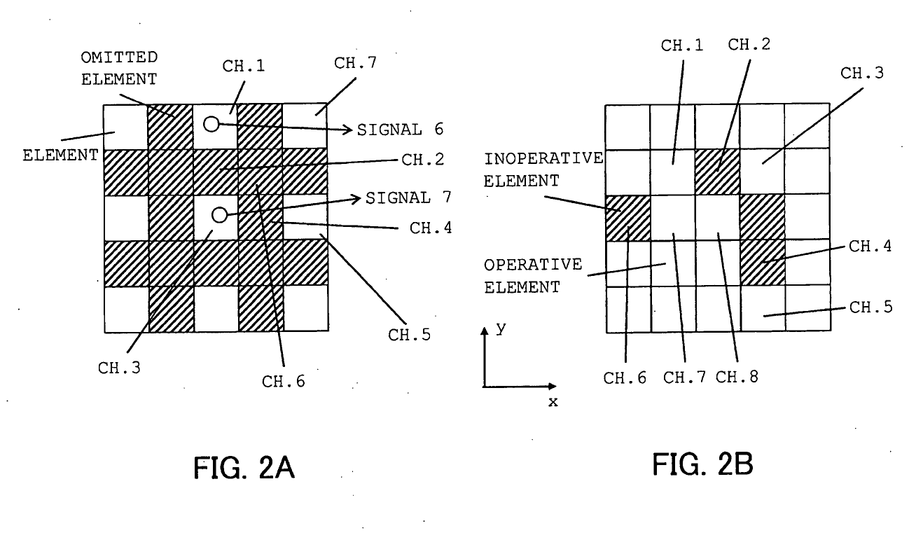

The ultrasonic probe 5 is an acoustic detector in which a plurality of elements for detecting acoustic waves are arrayed in the in-plane direction, and can acquire signals at a plurality of locations at the same time. FIG. 2A illustrates a part of the elements of the ultrasonic probe 5. A white portion in FIG. 2 indicates that an operative element exists which is operating normally. In a half tone portion, no operative element exists, or an electrode is not connected. The ultrasonic probe 5 in FIG. 2A is a sparse array probe, where no elements exist at positions adjacent to an element.

### (Memory)

The memory 9 records a position of each element on the probe, a position of an omitted element, and the correspondence of an element position and omitted element position. In the case of the above mentioned sparse array probe, an omitted element is a portion between elements which are intentionally spaced. This omitted position is a position for which a pseudo-signal is generated on the probe. In other words, a pseudo-signal to be generated is a signal which should be received by an element if the element is assumed to be in the omitted position. In the case of a standard probe, where elements are two-dimensionally arranged or one-dimensionally arranged, an omitted element is an inoperative element among the elements on the probe.

It can be determined whether an element is an inoperative element or not by checking whether the sensitivity of the element is a predetermined threshold or less. Hence in the memory 9, it may be recorded whether the element is an inoperative element or not, or the sensitivity of the element may be recorded for judging whether this element is an inoperative element or not. An operative element, on the other hand, is an element of which sensitivity is higher than a predetermined threshold.

### (Pseudo-Signal Generator)

Signals 6 and 7 (signals corresponding to the operative elements of CH. 1 and CH. 3 in the case of FIG. 2A), which are output from the ultrasonic probe 5, are input to the pseudo-signal generator 8. The pseudo-signal generator 8 refers to the positions of the signals 6 and 7 which were input and the neighboring omitted element positions in the memory 9, and determines whether there is an omitted element position sandwiched by the signal 6 and signal 7 (CH. 2 in the case of FIG. 2A), as shown in FIG. 2A. If the omitted position exists, the pseudo-signal generator 8 calculates the correlation of the signals 6 and 7, and generates a pseudo-signal 10 for the omitted position using the calculation result.

A pseudo-signal is generated according to the following procedure.

A case of generating a pseudo-signal at time to will be described. If the time functions t of signals 6 and 7 are f₁ and f₃ respectively, then the cross correlation h of the pseudo-signal is given by the following expression (1).

[Math. 1]

h(τ)=∫_{-T}^{T}f₁(t₀+t−τ)·f₃(t₀+t+τ)dt(−t₁≦τ≦t₁) (1)

Here T denotes a time width of the photoacoustic signal from a single object. τ takes a value in the −t₁ to t₁ range. t₁ is a maximum time when the phases of the photoacoustic signals in the signal 6 and signal 7 are shifted. The time lag Δt of the signals is double the time τ when the correlation h is highest, and the value k (t₀) generated at time to of the pseudo-signal is calculated as expression (2).

[Math. 2]

k(t₀)=(f₁(t₀−Δt/2)+f₃(t₀+Δt/2))/2 (2)

The pseudo-signals are generated, with to being changed as required.

Here it is assumed that an omitted element is in a mid-point of the signals 6 and 7, but if the omitted element is not in the mid-point of the signals 6 and 7, such as a case of generating a pseudo-signal at the CH. 4 position using CH. 3 and CH. 5 in FIG. 2B, then expression (1) becomes expression (3).

[Math. 3]

h(τ)=∫_{-T}^{T}f₃(t₀+t−2τ)·f₅(t₀+t+τ)dt(−t₁≦τ≦t₁) (3)

Here function f₃ corresponds to the signal in CH. 3 and the function f₅ corresponds to the signal in CH. 5. In this case, time lag Δt is 3τ, and the pseudo-signal is given by expression (4).

[Math. 4]

k(t₀)=(f₃(t₀−Δt·2/3)+2·f(t₀+Δt/3))/3 (4)

At this time, it is preferable that the maximum value t₁ of the time lag and the value of the signal time width T from the single light absorber are determined as follows.

When the sound velocity of the object is v, the length of the long side of the ultrasonic probe is A, the distance between the probe and the absorber in the object is L, the width between elements having signals is s, and the time of the pseudo-signal is t₀, then the time difference t₁ can be calculated by expression (5).

[Math. 5]

t₁=(\sqrt{A²+L²}−{square root over ((A−s)²+L²))}/v (5)

L is given by expression (6).

[Math. 6]

L=(t₀·v)²−(A−s)² (6)

The signal time width T from the single light absorber is determined by the central frequency of the probe, the response function of the probe, the size of the light absorber and the sound velocity inside the object, but typically, the signal time width T is approximately two to four times the reciprocal number of the central frequency.

The elements in CH. 1 and CH. 5, for example, can be used to generated a pseudo-signal to interpolate the omitted element signal in CH. 6 shown in FIG. 2A. In this case, in expression (1) and expression (2), f₃ is replaced with f₅ which is the signal in CH. 5. In other words, the pseudo-signal k′ (t₀) to be generated is given by expression (7). Δt′ is a double of the time at which correlation of the signal f₁ in CH. 1 and the signal f₅ in CH. 5 is highest.

[Math. 7]

k′(t₀)=(f₁(t₀−Δt′/2)+f₅(t₀+Δt′/2))/2 (7)

The pseudo-signal in CH. 6 can also be generated by four element signals in CH. 1, CH. 3, CH. 5 and CH. 7. In this case, not only the pseudo signal k′ (t₀) generated from the signal in CH. 1 and the signal in CH. 5 shown in expression (7), but also the pseudo-signal k″ (t₀) generated from the signal f₃ in CH. 3 and the signal f₇ in CH. 7 is used. This k″ (t₀) is given by expression (8). Δt″ is a double of the time at which the correlation of the signal in CH. 3 and the signal in CH. 7 is highest.

[Math. 8]

k′(t₀)=(f₃(t₀−Δt″/2)+f₇(t₀+Δt″/2))/2 (8)

Then the pseudo-signal k′(t₀) and the pseudo-signal k″ (t₀) are added to generate the pseudo-signal in CH. 6. If a pseudo-signal is generated using more signals like this, the pseudo-signal can be generated more accurately. The pseudo-signal generator may select an appropriate element signal according to the position on the probe, where the pseudo-signal is generated. Another pseudo-signal may be generated by the generated pseudo-signal.

### (Signal Processor)

A plurality of element signals from the probe 5 and the pseudo-signal 10 generated by the pseudo-signal generator 8 are input to the signal processor 11. The signal processor 11 reconstructs the image using the signals which are input, and generates the image data of the object.

For the image reconstruction algorithm for generating the image data, back projection in a time domain or a Fourier domain, for example, which is normally used in tomography technology, can be used. If it is allowable to take considerable time for reconstruction, such an image reconstruction method as the iterative method, based on iterative processing, may be used. Typical examples of image reconstruction methods for PAT are a Fourier transform method, a universal back projection method and a filtered back projection method.

### (Display Unit)

An image of the absorption coefficient distribution computed by the signal processor is displayed. MIP (Maximum Intensity Projection) images or sliced images can be displayed, but other display methods may be used.

Here a case of a medical photoacoustic diagnostic apparatus is shown as an example of a photoacoustic diagnostic apparatus, but the present invention can preferably be applied to various ultrasonic apparatuses of which testing targets are objects, other than for medical purposes.

Now the case of an ultrasonic diagnostic apparatus will be described, focusing on the differences from a photoacoustic apparatus.

### (Operation of Ultrasonic Diagnostic Apparatus)

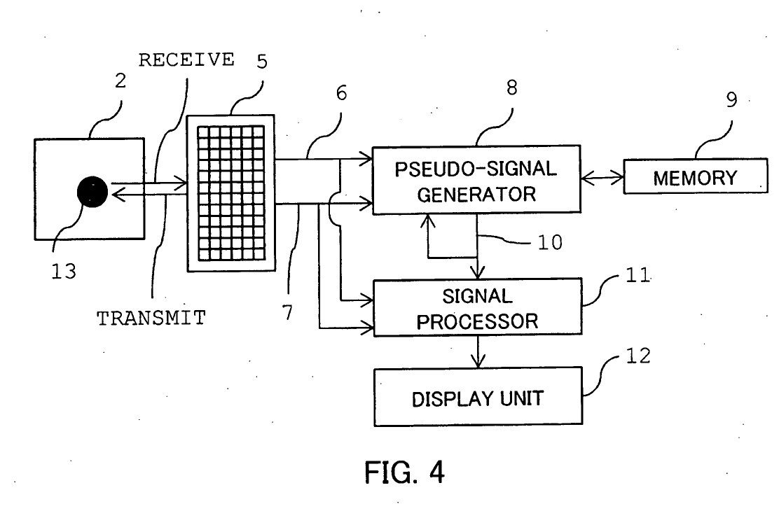

FIG. 4 is a block diagram depicting a configuration of an ultrasonic diagnostic apparatus according to the present invention. As FIG. 4 shows, the ultrasonic diagnostic apparatus according to the present invention transmits an ultrasonic wave from a probe 5 to an object 2 to be measured. An acoustic scatterer 13 in the object 2 reflects the ultrasonic wave transmitted from the ultrasonic diagnostic apparatus. The reflected ultrasonic wave is converted into electric signals by the probe 5. The electric signals are amplified and converted into digital signals, then the portions where signals are omitted are interpolated by the pseudo-signal generator 8. Then all the signals, including the pseudo-signals and the signals received from the operative elements, are processing by “delay and sum”, and are displayed by the display unit 12.

In the case of the ultrasonic diagnostic apparatus, a laser unit of the photoacoustic diagnostic apparatus has a function corresponding to the ultrasonic transmission from the probe 5. The ultrasonic probe transmits pulsed or continuous ultrasonic waves. The light absorber of the photoacoustic diagnostic apparatus corresponds to the acoustic scatterer. The transmitting ultrasonic probe need not be the same as the receiving ultrasonic probe 5.

In the above description, the pseudo-signal is generated using adjacent elements, but a pseudo-signal can also be generated using two or more neighboring elements. In the above embodiments, a two-dimensional probe where elements are arranged two-dimensionally, is used, but pseudo-signals can also be generated using a one-dimensional probe, where elements are arranged one-dimensionally.

### Example 1

Now in this example, a concrete case of imaging a simulation object, by applying the acoustic wave processor of the present invention to the photoacoustic diagnostic apparatus, will be described.

For the laser light source, an Nd:YAG laser is used. From this laser source, pulsed light in the nanosecond order, having a wavelength of 1064 nm, is irradiated onto the simulation object. The simulation object is water of which sound velocity v is 1500 m/s. The light absorber is a rubber wire, which is hung at a location 20 mm in front of the ultrasonic probe.

For the ultrasonic probe 5, a sparse array probe, where no elements exist at positions adjacent to an element, is selected. The size of the ultrasonic probe is 30 mm×46 mm, the element width d is 1 mm, and the distance s between elements is 2 mm. This means that the ultrasonic probe has 15×23 elements. A signal is output from the probe 30 times on average, and becomes digital signals by analog-digital conversion. The sampling frequency is 20 MHz. The elements of the sparse array probe are arranged in a form, as shown in FIG. 2A, so as to create a predetermined space between elements.

The value of time lag t₁, due to the generation of a pseudo-signal, is determined as follows. If the sound velocity v of the simulation object is 1500 m/s, length A of the long side of the ultrasonic probe is 46 mm, the distance L between the probe and the absorber in the object is 20 mm, and the width s between elements having signals is 2 mm, then the time lag t₁ is 1.2 μs based on expression (5). The signal width T from the single light absorber is determined by the central frequency of the probe, the response function of the probe, the size of the light absorber and the sound velocity of the simulation object, and is 2.4 μs here.

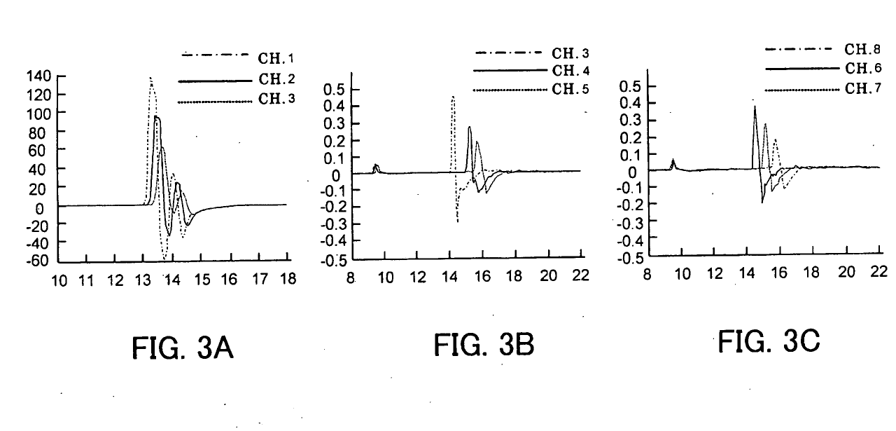

A pseudo-signal is generated using the time lag t₁ and the signal width T. FIG. 3A shows the result. The dotted lines in FIG. 3A are element signals received by CH. 1 and CH. 3. It is clear that the phases of CH. 1 and CH. 3 have shifted. The solid line CH. 2 indicates the pseudo-signal regenerated from the received signals.

Using the above method, the omitted elements on the probe shown in FIG. 2A are interpolated using the pseudo-signals as follows.

Since the position of CH. 4 is a position sandwiched by the operative elements in CH. 3 and CH. 5 in the x direction, interpolation is performed using the element signals of these two elements.

Since the position of CH. 2 is a position sandwiched by the operative elements in CH. 1 and CH. 3 in the y direction, interpolation is performed using the element signals of these two elements.

Then the pseudo-signal in the position of CH. 6 in FIG. 2A is generated using two pseudo-signals generated in the positions of CH. 4 and CH. 2. The pseudo-signal in the position of CH. 6 may be generated using the element signals of the operative elements in the position of CH. 1 and CH. 5 instead. The other omitted elements can also be interpolated using the element signals of the operative elements and pseudo-signals in the same manner.

After generating the pseudo-signals, the image is reconstructed by the back projection method in the time domain using the element signals and the pseudo-signals, and this image is generated.

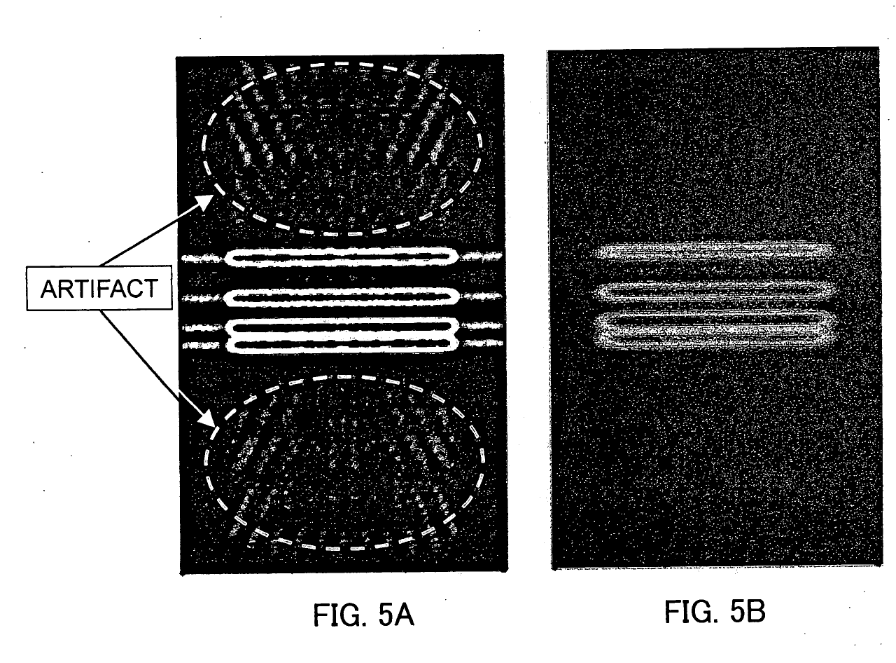

Now an effect of carrying out the present invention will be described. FIG. 5A shows the absorption coefficient distribution displayed as an MIP (Maximum Intensity Projection) image in the case of not interpolating omitted elements. In FIG. 5A, an artifact is seen radially from the light absorber. On the other hand, less artifact is seen in the image in FIG. 5B, which has been interpolated with pseudo-signals. Therefore it is confirmed that the present invention has an effect to decrease the artifact which appears due to omitted elements.

In this example, the sparse array probe, on which the element pitch is constant, is used as the ultrasonic probe, but in the case of the omitted elements that are not equally spaced, or in the case of the space of omitted elements being larger or smaller than the size of the element as well, a similar effect can be implemented.

### Example 2

In Example 1, the sparse array probe on which elements are intentionally omitted in a regular pattern was described. In this Example 2, an ultrasonic apparatus having a probe on which elements are omitted because of the presence of inoperative elements will be described as an example. Since the other configuration is the same as Example 1, mainly the portion that is different from Example 1 will be described herein below.

The size of the ultrasonic probe according to this example is mm×46 mm, the element width d is 2 mm, and the distance s between elements is also 2 mm, just like Example 1, and the ultrasonic probe has 15×23 elements. The probe has inoperative elements, and the ratio of the inoperative elements in all the channels is 26%. The light absorber is a rubber wire which is disposed in parallel with the y direction at a position 45 mm distant from the probe (L=45 mm). The simulation object is castor oil, and the sound velocity v is 1400 m/s.

The pseudo-signal generator refers to a memory 9 recording the positions of inoperative elements and the positions of operative elements, and selects neighboring operative elements required for generating pseudo-signals in the positions of the inoperative elements. In concrete terms, for the inoperative element CH. 2, the pseudo-signal generator selects neighboring operative elements CH. 1 and CH. 3 in the x direction, as shown in FIG. 2B. The pseudo-signal generator takes the correlation between the element signals in CH. 1 and CH. 3, and generates and interpolates the pseudo-signals.

Interpolation is performed in the same manner for the other inoperative elements. At this time, a pseudo-signal is generated using the neighboring elements in the y direction if there are no neighboring operative elements in the x direction. In this case, correlation is calculated regarding the signal width T from the single light absorber as 2.4 μs, and the time lag t₁ as 2.0 μs.

If there is no operative element in neighboring positions, as in the case of the y direction of CH. 4, pseudo-signals are generated using element signals in the positions of CH. 3 and CH. 5.

FIG. 3B shows a signal form of the pseudo-signal generated in the position of CH. 3 using the element signals in the positions of CH. 5 and CH. 4. It is shown that the signal of CH. 4 is generated on the CH. 5 side of CH. 3 and CH. 5.

If the element is on the edge of the probe in the x direction, as in the case of the inoperative element CH. 6, the element signals of the operative elements sandwiching the inoperative element in the y direction can be used. It is also possible to generate a pseudo-signal using the element signals of CH. 7 and CH. 8, which are in, the same positional relationship as CH. 6 in the x direction. FIG. 3C shows a signal form of the pseudo-signal in the position of CH. 6 generated from the element signals of CH. 7 and CH. 8. It is shown that the signal of CH. 6, indicated by the solid line, is generated before the photoacoustic signals of CH. 7 and CH. 8 indicated by the dotted lines.

After generating the pseudo-signals, the image is reconstructed by the back projection method in the time domain using the element signals and the pseudo-signals, and this image is generated.

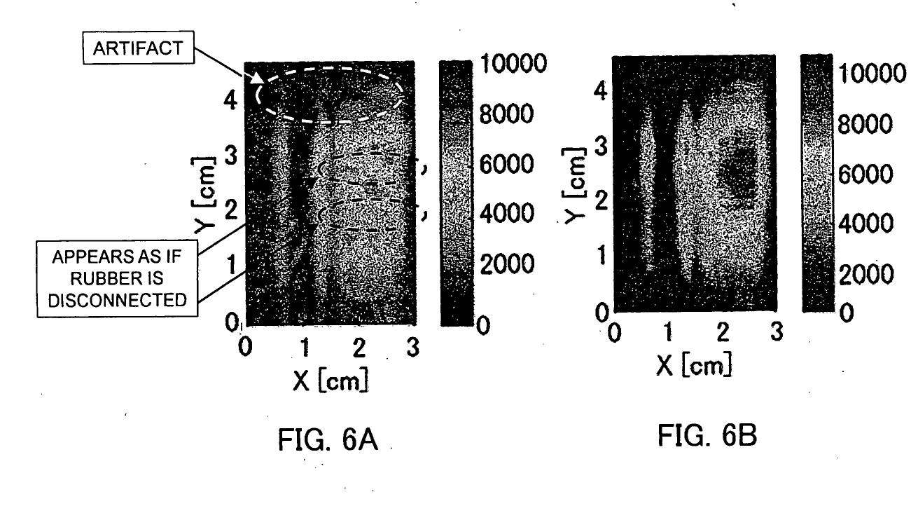

The effect of carrying out the present invention will be described next. FIG. 6B shows an image acquired using the pseudo-images and being displayed as an MIP image, and FIG. 6A shows an image where signal interpolation was not performed. In the image in FIG. 6A, an artifact is seen radially from the light absorber, and the rubber wire, which is actually continuous in the vertical direction, is disconnected. In the image in FIG. 6B, however, there is no radial artifact, and the rubber wire appears to be continuous. It is confirmed that the present invention decreases artifacts which appear due to inoperative elements.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-262390, filed on Nov. 25, 2010, which is hereby incorporated by reference herein in its entirety.

1. An object information acquiring apparatus, comprising:
a probe which includes a plurality of elements that receive an acoustic wave propagated through an object to generate element signals;
a pseudo-signal generator which computes a phase shift between element signals received by at least two elements out of said plurality of elements, and generates a pseudo-signal to be received at a position on said probe that is different from the positions of the elements that have received the element signals in use of a result of computation; and
a signal processor which obtains object information based on the element signals received by said plurality of elements and the pseudo-signal.

2. The object information acquiring apparatus according to claim 1, wherein said pseudo-signal generator generates the pseudo-signal by computing the phase shift by determining correlation of the element signals received by at least two of said elements, and determining time of the phase shift and a form of the pseudo-signal in use of the result of the computation.

3. The object information acquiring apparatus according to claim 1, wherein said signal processor acquires the object information by performing delay and sum using the plurality of element signals and the pseudo-signal.

4. The object information acquiring apparatus according to claim 1, wherein said signal processor acquires the object information by performing back projection using the plurality of element signals and the pseudo-signal.

5. The object information acquiring apparatus according to claim 1, wherein said probe is a sparse array probe of which said elements are disposed with a predetermined spacing between them, and the position on said probe where the pseudo-signal is generated is a space between said elements.

6. The object information acquiring apparatus according to claim 1, wherein the position on said probe where the pseudo-signal is generated is a position of an element of said elements that has sensitivity equal to a predetermined threshold or less.

7. The object information acquiring apparatus according to claim 6, further comprising a memory in which sensitivity values of said plurality of elements in said probe are recorded,
wherein said pseudo-signal generator determines whether a given element of said plurality of elements is an element whose sensitivity is the predetermined threshold or less, based on the sensitivity values of said elements recorded in said memory.

8. The object information acquiring apparatus according to claim 1, wherein said pseudo-signal generator generates a pseudo-signal using element signals received by ones of said elements which are disposed at positions sandwiching the position on said probe where the pseudo-signal is generated.

9. The object information acquiring apparatus according to claim 1, wherein said probe is a probe where said elements are two-dimensionally arranged.

10. The object information acquiring apparatus according to claim 1, wherein said probe is a probe where said elements are one-dimensionally arranged.

11. The object information acquiring apparatus according to claim 1, wherein the acoustic wave propagated through the object is a photoacoustic wave generated from a light absorber in the object when light is irradiated onto the object.

12. The object information acquiring apparatus according to claim 1, wherein the acoustic wave propagated through the object is an acoustic wave reflected by an acoustic scatterer in the object when the acoustic wave is transmitted to the object.
